(19) United States
(12) Patent Application Publication
(10) Pub. No.: US 2009/0014688 A1
(43) Pub. Date: Jan. 15, 2009

(54) Semiconductor Nanoparticles and Manufacturing Method of The Same

(75) Inventors: Hideki Hoshino, Tokyo (JP); Kazuya Tsukada, Kanagawa (JP); Hisatake Okada, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLA MEDICAL & GRAPHIC, INC., Tokyo (JP)

(21) Appl. No.: 12/087,936

(22) PCT Filed: Jan. 16, 2007
(86) PCT No.: PCT/JP2007/050495

§ 371 Date: Jul. 17, 2008

(30) Foreign Application Priority Data
Jan. 27, 2006 (JP) JP2006-019456

(51) Int. Cl. C09K 11/02

(52) U.S. Cl. 252/301.36

(57) ABSTRACT

A process for the production of semiconductor nanoparticles which realizes both uniform crystallite size and high crystallinity with the agglomeration thereof inhibited. This process is characterized by comprising the step (a) of generating nano-size particles from a semiconductor raw material and dispersing the particles in a gas phase, the step (b) of heat-treating the particles while keeping the particles in a state dispersed in the gas phase, and the step (c) of collecting the heat-treated particles immediately after the heat treatment with a solution of a surface modifier for modifying the surfaces of the particles.

### TECHNICAL FIELD

The present invention relates to a manufacturing method of semiconductor nanoparticles, as well as semiconductor nanoparticles manufactured by the above method and semiconductor nanoparticles which result in a narrow half value width of emitted light.

### TECHNICAL BACKGROUND

Broadly classified manufacturing methods of semiconductor nanoparticles include a gas phase method and a liquid phase method. Of these, the gas phase method is one capable of industrially manufacturing semiconductor nanoparticles via a gas phase reaction (for example, a thermal decomposition reaction) of semiconductor raw materials. However, the above method carries drawbacks such that secondary aggregation of formed semiconductor nanoparticles is commonly unavoidable. On the other hand, as a conventional liquid phase method exemplified are the, following two methods:

(1) One is a method in which an aqueous raw material solution is allowed to be present in non-polar organic solvents in the form of reverse micelles, and crystals are allowed to grow in the above reverse micelle phase (hereinafter referred to as a “reverse micelle method”). In the above method, it is possible to employ relatively inexpensive salts as a raw material. However, since this method is carried out at a relatively low temperature which does not exceed the boiling point of water, crystallinity of semiconductor nanoparticles becomes insufficient, whereby properties such as light absorbing and emitting characteristics or high refractive index of semiconductor nanoparticles have not always been as desired (refer, for example, to Non-Patent Document 1). Further, surface active agents, which are necessary to stabilize the reverse micelles, remain on the surface of product particles, whereby occasionally, the resulting thermal stability and dispersibility have deteriorated.

(2) The other is a method in which thermally decomposable raw materials are poured into liquid phase organic media at a relatively high temperature, whereby crystals are allowed to grow (hereinafter referred to as the “hot soap method”), and each of cadmium selenide nanocrystals (refer, for example, to Non-Patent Document 2), nanocrystals of γ-Fe₂O₃, Mn₃O₄, or Cu₂O (refer, for example, to Non-Patent Document 3) has been reported. Compared to the above reverse micelle method, the synthesis reaction is performed at about 300° C. As a result, nanocrystal products excel in crystallinity and light absorption and light emission characteristics, compared to the reverse micelle method. However, its industrial application has been limited due to the following points: organic metals such as dimethyl cadmium or diethyl zinc, which are relatively expensive and chemically unstable, are employed as a raw material, trioctylphosphine oxide or hexadecylamine, which are relatively expensive, are employed as a reaction solvent, and crystallinity of products excessively varies due to the change of reaction conditions such as scale-up.

As noted above, each of the conventional technologies exhibits drawbacks, and further improvement of the manufacturing method has been sought. Further, proposed is a semiconductor nanoparticle manufacturing method which includes a process which forms hydrosol of a semiconductor nanocrystal, as well as a process in which an organic layer containing lipid-soluble surface modifying molecules capable of bonding to the above semiconductor nanocrystals is brought into contact with the above hydrosol, followed by extraction into the organic phase (refer, for example, to Patent Document 1). However, since the above manufacturing method includes a synthetic reaction commonly between about 150-about 500° C., crystallinity of the resulting semiconductor nanoparticles has been insufficient, when compared to the semiconductor nanoparticles prepared via the gas phase method.

Further, it is common knowledge that when crystallite sizes differ, the wavelength of light emitted by semiconductor nanoparticles also differs. When employing the above manufacturing methods of semiconductor nanoparticles, it has been difficult to achieve uniform crystallite size. Consequently, the crystallite size of the semiconductor nanoparticles has exhibited a broader size distribution, and the half value width has been in the relatively broad range of 50-200 nm.

Patent Document 1: Japanese Patent Publication Open to Public Inspection (hereinafter referred to as JP-A) No. 2003-73126
Non-Patent Document 1: B. S. Zou et al.; Int. J. Quant. Chem. Volume 72, 439 (1999)
Non-Patent Document 2: J. E. B. Katari et al.; J. Phys. Chem., Volume 98, 4109-4117 (1994)
Non-Patent Document 3: J. Rockenberger et al.; J. Am. Chem. Soc., Volume 121, 11595-11596 (1999)

### DISCLOSURE OF THE INVENTION

### Problem to be Dissolved by the Invention

When the above conventional manufacturing methods of semiconductor nanoparticles are employed, it has been difficult to prepare semiconductor nanoparticles of a uniform crystallite size and high crystallinity, while retarding secondary aggregation.

An object of the present invention is to provide a manufacturing method of semiconductor nanoparticles, in which uniform size of crystallites and high crystallinity are simultaneously realized while retarding secondary aggregation, and semiconductor nanoparticles which exhibit a narrow half value width of emitted light due to the narrow distribution of the crystallite size.

In view of the foregoing, investigations were conducted, and the following was discovered. By employing a specified manufacturing method of semiconductor nanoparticles, it was possible to prepare semiconductor nanoparticles which exhibit a uniform crystallite size and high crystallinity, while retarding secondary aggregation.

Namely, the present invention is characterized in that in a manufacturing method of semiconductor nanoparticles which manufactures semiconductor nanoparticles comprises:
(Process A) in which a group of nano-size particles is generated from semiconductor raw materials and the group of the resulting particles is dispersed into a gas phase;
(Process B) in which, while maintaining a state in which a group of the above particles is dispersed into a gas phase, a thermal process is applied to the above particles; and
(Process C) in which immediately after applying the above thermal process to the group of particles, the group of the thermally processed particles is collected by a surface-modifying agent solution which achieves surface modification of the particles the group of which has been applied the thermal process, immediately after applying the thermal process to the group of particles.

Further, the present invention includes semiconductor nanoparticles of a half value width in the range of 10-40 nm.

### Advance of the Invention

The manufacturing method of semiconductor nanoparticles of the present invention enables preparation of semiconductor nanoparticles of a uniform crystallite size and high crylstallinity, while retarding secondary aggregation. Further, with the semiconductor nanoparticles of the present invention, which exhibit a half value width in the range of 10-40 nm, when employed as an indicator material, it is possible to simultaneously employ a wide variety of semiconductor nanoparticles which differ in their wavelength of emitted light.

### BRIEF DESCRIPTION OF THE DRAWING

FIG. 1 is a schematic view showing one example of the manufacturing apparatus of the present invention.

### DESCRIPTION OF SYMBOLS

10: semiconductor raw material

11: particle generating apparatus

12: inlet pipe

13: carrier gas

14: first connecting pipe

15: thermal processing apparatus

16: second connecting pipe

17: surface modifying agent solution

18: exhaust outlet

### BEST EMBODIMENT TO PRACTICE THE INVENTION

The present intention will now be specifically described.

### (Manufacturing Method of Semiconductor Nanoparticles)

The manufacturing method of the semiconductor nanoparticles of the present invention includes: (Process A) in which a group of nano-size particles is generated from semiconductor raw materials and the group of the resulting particles is dispersed into a gas phase; (Process B) in which while maintaining a state in which a group of the above particles is dispersed into a gas phase, a thermal process is applied to the above particles; and (Process C) in which immediately after applying the above thermal process to the group of particles, the group of the thermally processed particles is collected by a surface-modifying agent solution which achieves surface modification, whereby nano-semiconductor particles having uniform crystal size and high crystallinity can be manufactured with inhibited second coagulation.

### <Process A>

Process A of the present invention is one in which a group of nano-size particles is generated from semiconductor raw materials and the group of the resulting particles is dispersed into a gas phase. In the present invention, semiconductor raw materials may appropriately be employed in either a liquid state or a solid state. The raw material is not particularly limited as long as it is capable of generating nano-size particles which are dispersible into a gas phase. When the state of the raw material is a solid phase, it is preferable to employ a laser exposure method. Further, when the state of the raw material is a liquid phase, it is preferable to employ an ultrasonic wave method, an electrostatic spraying method, a reduced pressure spraying method, or an ink-jet method. When semiconductor raw materials are in the liquid phase, previously employed may be amorphous nano-precursor dispersion or a solution which is prepared by dissolving nano-semiconductor materials in such a state as a nitrite. When the raw material is a solid phase state, it may be in an aggregated state or laminated on a substrate.

Further, carrier gases which are employed to disperse the above group of particles into a gas phase are selected depending on the semiconductor raw material and the group of targeted nanoparticles. Carrier gases commonly include inert ones such as nitrogen or argon, air, oxygen, oxygen enriched air, and hydrogen.

In practice, employed as semiconductor raw material is an aqueous solution incorporating zinc acetate, manganese acetate, and sodium sulfide, and when ZnS:Mn semiconductor nanoparticles are prepared, one of the preferable embodiments is that a gas mixture of nitrogen and hydrogen sulfide is employed as a carrier gas.

Further, when Si semiconductor nanoparticles are to be prepared by employing colloidal silica as a semiconductor raw material, one of the preferred embodiments is that reducing gases such as hydrogen are employed as a carrier gas.

As another example, when CdSe semiconductor nanoparticles is to be prepared by employing cadmium iodide and sodium selenide as a semiconductor raw material, one of the preferred embodiments is that inert gases such as nitrogen are employed as a carrier gas.

Further, when the concentration of the group of particles in the carrier gases is excessive high, the diameter of manufactured semiconductor nanoparticles increases, while when the concentration of the group of particles in the carrier gases is excessive low, a decrease in productivity occasionally results. Consequently, it is preferable to regulate pressure corresponding to the generated amount of the group of particles.

In practice, the concentration of the group of particles in carrier gases is preferably in the range of 1×10⁻⁷-1×10⁻¹ mol/L, but is more preferably in the range of 5×10⁻⁶-5×10⁻³ mol/L. It is preferable that the concentration exceeds the lower limit, whereby no decrease in productivity results. It is also preferred that the concentration is at most the upper limit, since no increase in the diameter of the group of semiconductor nanoparticles results. Pressure may be regulated in response to the generated amount of the group of particles so that the concentration of the group of particles in carrier gases is within the above range.

### <Process B>

Process B of the present invention is one in which while maintaining a state in which a group of the particles generated in Process A is dispersed into a gas phase, a thermal process is applied to the above particles.

The thermal process is not particularly limited as long as it is possible to apply the thermal Process At the specified temperature for the specified time to the above group of the particles generated by Process A while maintaining the dispersed state. “Dispersed state”, as described herein, refers to the state in which particles are suspended in a gas phase without falling down due to gravity. Further, “thermal process”, as described herein, means that by applying thermal energy to semiconductor raw material, the raw material is allowed to react with each other to control the crystalline structure of the raw material.

Further, specific temperatures are appropriately selected depending on the semiconductor raw material and the targeted semiconductor nanoparticles, and are commonly selected in the range of 700-1,700° C. When the temperature exceeds the lower limit, it is possible to realize higher crystallinity. Further, it is preferable that the temperature is at most the upper limit, whereby excessive load is not applied to the apparatus. Temperature of the thermal process is set by controlling devices employed for the thermal process such as an electric heater. In practice, when the targeted semiconductor nanoparticles are composed of ZnS:Mn, the temperature is commonly in the range of 900-1500° C., but is preferably in the range of 1,100-1,250° C. When the targeted semiconductor nanoparticles are composed of Si, the temperature is commonly in the range of 1,000-1,500° C., but is preferably in the range of 1,100-1,250° C. Further, when the targeted semiconductor nanoparticles are composed of CdSe, the temperature is commonly in the range of 700-1,100° C., but is preferably in the range of 800-900° C.

Further, the above specified time changes depending on the semiconductor raw materials, as well as the targeted semiconductor nanoparticles and diameter thereof. The time is appropriately selected to be commonly in the range of 0.1-10 seconds, but preferably in the range of 1-3 seconds.. The above time range is preferred since secondary aggregation of particles is retarded in the gas phase. The thermal processing time is set by controlling the flow rate and pressure of carrier gases, and the size of vessel to achieve the thermal process.

### <Process C>

Process C, as described in the present invention, is one in which immediately after applying the thermal process of Process B to the group of particles, the group of the thermally processed particles, as above, is collected by a surface-modifying agent solution which achieves surface modification.

During the above process, it is possible to retard secondary aggregation by collecting the group of particles to which the above thermal process have been applied by a surface modifying agent solution which modifies the surface of the above particles. As above surface modifying agents, conventional surface modifying agents may appropriately be selected depending on the manufactured semiconductor nanoparticles.

Modification embodiments of the above surface modifying agents are not particularly limited. For example, surface modifying agents may form a chemical bond with the surface of semiconductor nanoparticles, or result in physical adsorption thereon. Further, the above surface modifying agent solution may incorporate additives such as surface active agents, dispersion stabilizing agents, or antioxidants.

In practice, when semiconductor nanoparticles to be manufactured are composed of ZnS:Mn, it is preferable that polyethylene (4,5) lauryl ether acetic acid or polyoxyethylene (1)lauryl ether phosphoric acid is employed as the surface modifying agent. When semiconductor nanoparticles to be manufactured are composed of Si, it is preferable that various silane coupling agents are employed as the surface modifying agent. Further, when semiconductor nanoparticles to be manufacture are composed of CdSe, it is preferable that mercaptopropionic acid or mercaptoundecanic acid is employed as the surface modifying agent.

Further, solvents in the surface modifying solution are appropriately selected depending on the semiconductor nanoparticles to be manufactured and the employed surface modifying agents, and in view of cost and environmental concerns, water based solvents are preferred.

### [Semiconductor Nanoparticles in the Range of 10-40 nm of the Half Value Width of Emitted Light]

Other than the above semiconductor nanoparticles, listed are the following compounds as those in the present invention. Examples thereof include Groups I-VII compound semiconductors such as CuCl, Groups II-VI compound semiconductors such as CdS or ZnSe, Groups III-V compound semiconductors such as InAs, semiconductor crystals of Group IV semiconductors, and metal oxides such as TiO₂, as well as composite materials thereof. Examples of the above composite materials include those which have a core-shell structure such as CdS core-CdSe shell, CdSe core-Cds shell, CdS core-ZnS shell, CdSe core-ZnS shell, CdS nano-crystal core-ZnS shell, CdSe nano-crystal core-ZnSe shell, or Si core-SiO₂ shell. The diameter of the above semiconductor nanoparticles is commonly in the range of 0.5-100 nm. When it is less than 0.5 nm, particles are modified at the atomic level or the molecules themselves, while when it exceeds 100 nm, they exhibit properties as a bulk. The diameter is preferably in the range of 0.5-50 nm, but is more preferably in the range of 1-10 nm. The shape of the above semiconductor nanoparticles is not particularly limited and include shapes such as sphere, rod, plate, thin film, fiber, and tube, and of these, the spherical shape is preferred.

When semiconductor nanoparticles, which emit light of a half value width in the range of 10-40 nm, are employed, for example, as a marking material, they are advantageous so that it is possible to simultaneously employ various semiconductor nanoparticles which differ in their wavelength of emitted light. However, when conventional methods to manufacture semiconductor nanoparticles are employed, it has been difficult to prepare semiconductor nanoparticles of a half value width of the emitted light in the range of 10-40 nm.

Semiconductor nanoparticles of a half value width in the range of 10-40 nm are required to result in a uniform size of crystallites and exhibit the targeted high crystallinity. It is possible to appropriately manufacture semiconductor nanoparticles of a half width value in the range of 10-40 nm, employing the aforesaid method (the manufacturing method of semiconductor nanoparticles).

### [One Example of Manufacturing Apparatus]

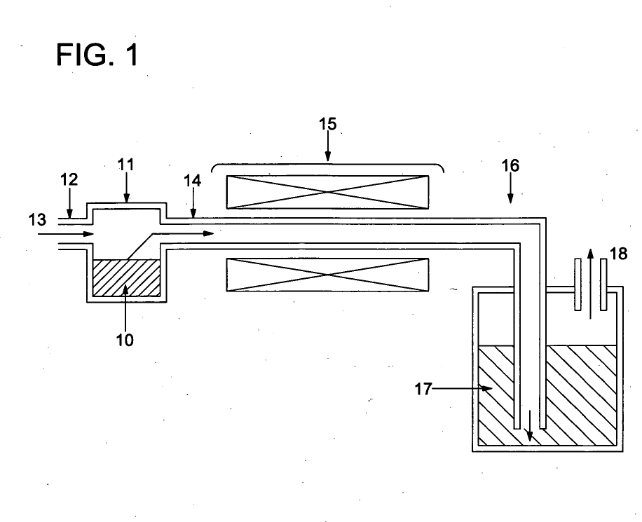

The manufacturing apparatus of the present invention will be described with reference to a drawing. FIG. 1 is a view showing one example of a manufacturing apparatus to realize the manufacturing method of semiconductor nanoparticles of the present invention.

Semiconductor raw material 10 is placed in particle generating apparatus 11, and a group of nano-size particles is generated. Carrier gas 13 is introduced into particle generating apparatus 11 via inlet pipe 12. A group of generated nano-size particles, which are in a dispersed sate in carrier gas 13, is introduced into thermal processing apparatus 15 via first connecting pipe 14. The group of particles introduced into thermal processing apparatus 15 is allowed to flow together with carrier gas 13, while maintaining the dispersed state, whereby thermal processing is carried out at the specified temperature for the specified time. Thereafter, a group of thermally processed nano-size particles is introduced into surface modifying agent solution 17 together with carrier gas 13 via second connecting pipe 16, and surface modification is affected. Carrier gas 13 is exhausted via exhaust outlet 18.

Since the group of thermally processed nano-size particles is collected via aforesaid surface modifying solution 16 without cooling which results in secondary aggregation followed by surface modification, no secondary aggregation occurs. Further, by allowing to maintain the dispersed state, particle growth during thermal processing is retarded, whereby it is possible to maintain the size of the group of nano-size particles generated by the particle generating apparatus.

### EXAMPLES

Appropriate embodiments of the present invention will now be further detailed with reference to examples, however the preset invention is not limited thereto.

### Example 1

In the following examples, the manufacturing apparatus illustrated in FIG. 1 was employed.

Colloidal silica suspension (2×10⁻³ mol/L) prepared by a sol-gel method was employed as semiconductor raw material 10. The above colloidal silica suspension was placed in particle generating apparatus 11, and liquid droplets were generated. Subsequently, the resulting liquid droplets were introduced into thermal processing apparatus 15 at a rate of 1 L/minute together with carrier gases 13 regulated to 3% hydrogen:97% nitrogen, followed by thermal processing at 1,180° C. for 1.5 seconds. Thereafter, immediately, a group of thermally processed nano-size particles was collected in an aqueous solution incorporating 2% by weight of a silane coupling agent (SILA-ACE S330, produced by Chisso Corp.), which was surface modifying agent solution 17, whereby Semiconductor Nanoparticles 1 were prepared. Their emission spectra and X-ray diffraction were determined. At that time, emission spectra during exposure to 260 nm exciting radiation were determined via an ultraviolet visible spectrophotometer (V-550, produced by JASCO Corp.), and luminance and the half value width of the emission spectra were evaluated. The resulting sample emitted red light at a peak of 670 nm. X-ray diffraction was performed by an automatic X-ray diffractometer (RINT 2000, produced by Rigaku Corp.), and the half value width of the diffraction peak was evaluated. Table 1 shows the results.

### Example 2

A colloidal silica suspension (7.5×10⁻⁴ mol/L) as semiconductor-raw material 10, which had been prepared by a sol-gel method, was placed in particle generating apparatus 11 which generated particles via an ultrasonic wave method, while the interior pressure of the above apparatus was reduced to 0.65 atmospheric pressure, whereby liquid droplets were generated. Subsequently, the liquid droplets were introduced at a rate of 1.5 L/minute into thermal processing apparatus 15 together with carrier gas 13 regulated to 3% hydrogen:97% nitrogen, followed by a thermal processing at 1,180° C. for 1.0 second. Thereafter, immediately, a group of the thermally processed nano-size particles together with carrier gas 13 was collected in an aqueous solution incorporating 2% by weight of a silane coupling agent (SILA-ACE S330, produced by Chisso Corp.) which was surface modifying agent solution 17, whereby semiconductor nanoparticles 2 were prepared. Emission spectra and X-ray diffraction of semiconductor nanoparticles 2, prepared as above were determined. On this occasion, emission spectra during exposure to 260 nm exciting radiation were determined via an ultraviolet visible spectrophotometer (V-550, produced by JASCO Corp.), and luminance-and the half value width of the emission spectra were evaluated. The resulting sample emitted red light at a peak of 670 nm. X-ray diffraction was performed by an automatic X-ray diffractometer (RINT 2000, produced by Rigaku Corp.), and the half value width of the diffraction peak was evaluated. Table 1 shows the results.

### Comparative Example 1

Semiconductor nanoparticles 3 were prepared in the same manner as Example 1, except that a group of thermally processed nano-size particles was collected via an electrostatic collector. Emission spectra and X-ray diffraction of semiconductor nanoparticles 3, prepared as above were determined. On this occasion, emission spectra during exposure to 260 nm exciting radiation were determined via an ultraviolet visible spectrophotometer (V-550, produced by JASCO Corp.), and luminance and the half value width of the emission spectra were evaluated. The resulting sample emitted red light at a peak of 670 nm. X-ray diffraction was performed by an automatic X-ray diffractometer (RINT 2000, produced by Rigaku Corp.), and the half value width of the diffraction peak was evaluated. Table 1 shows the results.

TABLE 1

| | | Emitted Light | |
|---|---|---|---|
| | | Half Value | X-ray Peak Half |
| | Luminance*¹ | Width (nm) | Value Width*² |
| Semiconductor | 136 | 37 | 0.72 |
| nanoparticles 1 | | | |
| Semiconductor | 156 | 24 | 0.56 |
| nanoparticles 2 | | | |
| Semiconductor | 100 | 86 | 1.00 |
| nanoparticles 3 | | | |

*¹Relative value when the luminance of semiconductor nanoparticles was 100
*²Relative value when the half value width of the diffraction peak of semiconductor nanoparticles 3 was 1.00

As can clearly be seen from Table 1, by employing the manufacturing method of semiconductor nanoparticles of the present invention, prepared were semiconductor nanoparticles which exhibited high luminance, resulted in a half value width of emission spectra in the range of 10-40 nm, and exhibited high crystallinity.

1. A manufacturing method of a semiconductor nanoparticle comprising:
generating a group of particles having nano-size from a semiconductor raw material and dispersing the group of particles into a gas phase;
applying a thermal process to the particles, while maintaining a state in which the group of particles is dispersed in a gas phase; and
collecting the group of particles which has been applied the thermal process by a solution of a surface-modifying agent which achieves surface modification of the particles the group of which has been applied the thermal process, immediately after applying the thermal process to the group of particles.

2. A semiconductor nanoparticle wherein the half value width of emitted light is in the range of 10-40 nm.

3. A semiconductor nanoparticle having a half value width of emitted light in the range of 10-40 nm, wherein said semiconductor nanoparticle is manufactured by the manufacturing method of the semiconductor nanoparticle described in claim 1.
